(19) United States
(12) Patent Application Publication
(10) Pub. No.: US 2024/0249376 A1
(43) Pub. Date: Jul. 25, 2024

(54) METHODS, SYSTEMS, AND NON-TRANSITORY COMPUTER-READABLE STORAGE MEDIA FOR SHARING A VEHICLE

(71) Applicant: Toyota Motor North America, Inc., Plano, TX (US)

(72) Inventor: Jason Zahorik, Torrance, CA (US)

(73) Assignees: Toyota Motor North America, Inc., Plano, TX (US); Toyota Jidosha Kabushiki Kaisha, Toyota-shi (JP)

(21) Appl. No.: 18/156,722

(22) Filed: Jan. 19, 2023

(51) Int. Cl. G06Q 50/30; G06Q 10/0631; G07C 5/00

(52) U.S. Cl. CPC G06Q 50/30; G06Q 10/06315; G07C 5/008

(57) ABSTRACT

A method for sharing a vehicle is provided. The method includes receiving an authorization for sharing the vehicle, obtaining vehicle data associated with the vehicle, obtaining external data obtained external to the vehicle, determining whether the vehicle meets criteria indicative of demand for sharing based on the vehicle data and the external data, and soliciting, in response to the determination that the vehicle meets the criteria for sharing, a user to share the vehicle for monetization.

### TECHNICAL FIELD

The present specification generally relates to monetizing privately owned vehicles that are not fully utilized. More specifically, systems, methods, and non-transitory computer-readable storage media of the present disclosure notify a user to share a vehicle of the user for monetization when the vehicle is determined to meet certain criteria for sharing.

### BACKGROUND

A vehicle sharing system often targets off-lease vehicles that are available for rental by a ride-share driver. However, privately owned vehicles also may be available for vehicle sharing. Vehicles (e.g., privately owned vehicles) may not be used for a certain period of time and can be offered to be shared. Owners of the vehicles may appreciate monetary gains when sharing the vehicles when the vehicles are not used by the owners.

### SUMMARY

In one embodiments, a method for sharing a vehicle is provided. The method includes receiving an authorization for sharing the vehicle, obtaining vehicle data associated with the vehicle, obtaining external data obtained external to the vehicle, determining whether the vehicle meets criteria indicative of demand for sharing based on the vehicle data and the external data, and soliciting, in response to the determination that the vehicle meets the criteria for sharing, the user to share the vehicle for monetization.

In another embodiment, a system for sharing a vehicle is provided. The system includes a processor, and a memory coupled to the processor. The processor is configured to receive an authorization for sharing the vehicle, obtain vehicle data associated with the vehicle, obtain external data obtained external to the vehicle, determine whether the vehicle meets criteria for sharing based on the vehicle data and the external data, and solicit, in response to the determination that the vehicle meets the criteria for sharing, the user to share the vehicle for monetization.

In yet another embodiment, a non-transitory computer-readable storage medium storing executable instructions is provided. When executed by a processor, the executable instructions cause the processor to receive an authorization for sharing the vehicle, obtain vehicle data associated with the vehicle, obtain external data obtained external to the vehicle, determine whether the vehicle meets criteria for sharing based on the vehicle data and the external data, and solicit, in response to the determination that the vehicle meets the criteria for sharing, the user to share the vehicle for monetization.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an illustrative system for sharing a vehicle according to one or more embodiments shown and described herein;

FIG. 2 schematically depicts components of a vehicle according to one or more embodiments shown and described herein;

FIG. 3 depicts an illustrative controller for implementing a method for sharing vehicle according to one or more embodiments shown and described herein; and

FIG. 4 depicts an illustrative flow diagram of processes for sharing a vehicle according to one or more embodiments shown and described herein.

### DETAILED DESCRIPTION

Embodiments of the present disclosure include systems and methods for sharing a vehicle for monetization. The vehicle is offered for sharing when a user opts-in for a sharing program. However, the opt-in may not immediately make the vehicle available for sharing. Vehicle data and external data are obtained to analyze whether the vehicle meets certain criteria for sharing. The vehicle data may be associated with the vehicle itself, for example, collected from the vehicle (e.g., CAN data), obtained from the vehicle manufacturer (e.g., vehicle specification), or obtained from user input. The external data may be obtained external to the vehicle. The external data may not be associated with the vehicle that is offered to be shared. The external data may provide evaluation metrics for analyzing demand for sharing. The demand may be associated with certain vehicle factors. The vehicle factors may be compared with the vehicle data to determine the degree of demand of each vehicle factor. When the vehicle is determined to meet the criteria for sharing, the user may be notified that the vehicle may be shared through the program. When the vehicle meets the criteria, the vehicle may be automatically scheduled for sharing based on a scope of the sharing provided by a user demanding the vehicle or a scope of the sharing provided by the user offering to share the vehicle. Information associated with the sharing schedule may be notified to the user.

The following will now describe embodiments of the systems and methods in more detail with reference to the drawings and where like numbers refer to like structures.

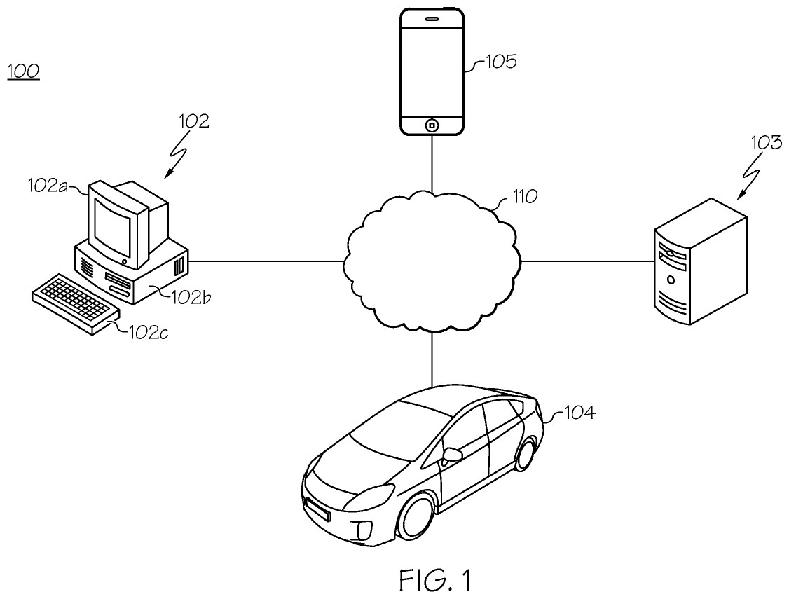

Referring to FIGS. 1-3, illustrative systems, vehicles, and non-transitory computer-readable storage media for implementing processes for sharing a vehicle according to embodiments of the present disclosure are depicted. In particular, FIG. 1 depicts an example system 100 implemented via a network 110 configured to perform processes of the present disclosure. The system 100 may include an interconnection of one or more devices, such as a computing device 102, a server 103, a vehicle 104, and a mobile device 105. The devices may be interconnected over the network 110. The network 110 may include a wide area network, such as the internet, a local area network (LAN), a mobile communications network, a public service telephone network (PSTN) and/or other network. In some embodiments, the network 110 may represent a peer-to-peer type network between devices. As used herein, a controller refers to any one of the computing device 102, the server 103, or the mobile device 105. In embodiments, the process for determining whether a vehicle meets criteria for vehicle sharing according to embodiments of the present disclosure may be implemented by one of the computing device 102, the server 103, or the mobile device 105, or a combination of the computing device 102, the server 103, or the mobile device 105.

The computing device 102 may include a display 102a, a processing unit 102b and an input device 102c, each of which may be communicatively coupled together and/or to the network 110. The computing device 102 may be a desktop computer, a server 103 or a mobile device 105, such as a personal computer, a laptop, a tablet, a smartphone, an application specification handheld device, or the like. The mobile device 105 may include an input device, such as a touch screen or keypad, and a display. The mobile device 105 may further include components such as a GPS for determining a location of the mobile device 105, an inertial measurement unit for measuring acceleration and angular velocity of the mobile device 105 along three mutually perpendicular axes. In some embodiments, the mobile device 105 may be implemented to acquire diving behavior of a user while the user is operating a vehicle. This information may be used in addition to or independently from CAN data, as described herein, to determine whether a vehicle meets criteria for vehicle sharing according to embodiments of the present disclosure.

The computing device 102 and/or the mobile device 105 may be used to enable the system 100 to access the CAN bus data from a vehicle 104 and/or for a user to provide information such as responses to survey questions to the system 100. The system 100 may also include one or more servers 103. The server 103 may be configured to perform one or more process steps of the methods described herein. For example, but without limitation, the sever 103 may be configured to provide a web based application to a computing device 102 or a mobile device 105 of the user to prompt the user for information and/or access to the CAN bus data of a vehicle 104. In some embodiments, as described in more detail herein, the server 103 is configured to ingest vehicle data, implement an artificial intelligence model or trained machine learning model to transform ingested vehicle data into a set of vehicle sharing parameters and determine whether a vehicle meets criteria for vehicle sharing based on the transformation of the ingested vehicle data, and output a notification.

The computing device 102 and/or the mobile device 105 may be used to enable the system 100 to access schedule information (e.g., a shared calendar) of the user to determine whether the system 100 may solicit the user to share the vehicle 104 based on the schedule information. For example, the system may solicit 100 the user to share the vehicle 104 during time set by the user indicating that the vehicle 104 is available for sharing, time scheduled for certain activities indicating that the user is not using the vehicle 104, or the like. The system 100 may suggest a certain time that the vehicle 104 will be in high demand for sharing and would like to solicit and/or notify the user to share the vehicle 104.

The server 103 may be configured to access and record the CAN data of a vehicle 104 for a predefined period of time or download previously logged CAN data from a vehicle 104, a computing device 102 or a mobile device 105. The server 103 may host a web based interface or an application by which a user (e.g., a vehicle owner) of a computing device 102 or mobile device 105 can access and interact with the process for submitting by the user and/or receiving by the system 100 an authorization for sharing the vehicle 104 according to embodiments of the present disclosure.

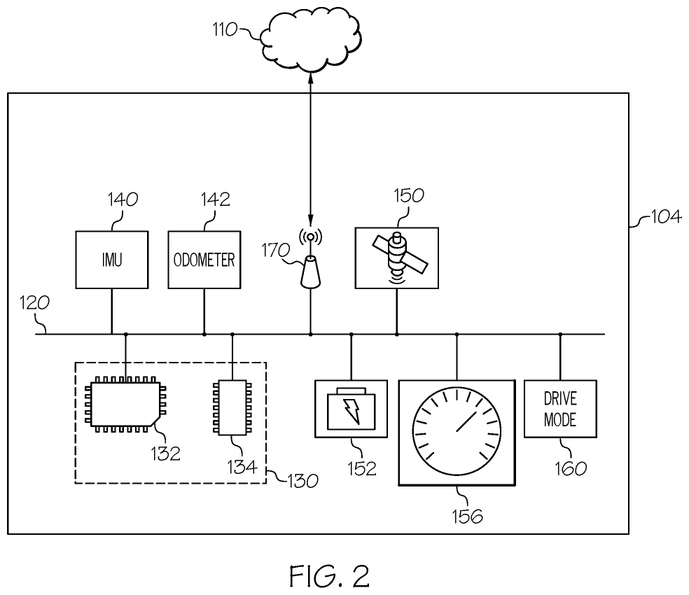

Referring to FIG. 2, a schematic of illustrative components of the vehicle 104 connected to a CAN bus 120 is depicted. The vehicle 104 may be an automobile, a watercraft, an airplane, a motor bike, a motor scooter, or the like. The vehicle 104 may include many components and sensors interconnected together via a CAN bus 120, which enables operational monitoring and control of the vehicle 104. It should be understood that FIG. 2 depicts a set of illustrative components and sensors of the vehicle 104 and that various other components and sensors may be include in the vehicle 104. For example, the vehicle 104 may include a vehicle controller 130 comprising a processor 132 and a non-transitory computer readable memory 134, an inertial measurement unit 140, an odometer 142, a location positioning system 150 (e.g., a global positioning system (GPS)), an auxiliary power system 152, a vehicle speed sensor 156, a drive mode system 160, and network interface hardware 170. These and other components of the vehicle 104 are communicatively connected to each other via a CAN bus 120. The vehicle 104 may further include an in-vehicle display to display various information from the components of the vehicle 104 or external information received via the network interface hardware 170. The display may be coupled to the CAN bus 120.

The CAN bus 120 may be formed from any medium that is capable of transmitting a signal such as, for example, conductive wires, conductive traces, optical waveguides, or the like. The CAN bus 120 may also refer to the expanse in which electromagnetic radiation and their corresponding electromagnetic waves traverses. Moreover, the CAN bus 120 may be formed from a combination of mediums capable of transmitting signals. In one embodiment, the CAN bus 120 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The vehicle controller 130 may be any device or combination of components comprising the processor 132 and the non-transitory computer readable memory 134. The processor 132 may be any device capable of executing the machine-readable instruction set stored in the non-transitory computer readable memory 134. Accordingly, the processor 132 may be an electric controller, an integrated circuit, a microchip, a computer, or any other computing device. The processor 132 is communicatively coupled to the other components of the vehicle 104 by the CAN bus 120. Accordingly, the bus 120 may communicatively couple any number of processors 132 with one another, and allow the components coupled to the CAN bus 120 to operate in a distributed computing environment. Specifically, each of the components may operate as a node that may send and/or receive data. While the embodiment depicted in FIG. 2 includes a single processor 132, other embodiments may include more than one processor 132.

The non-transitory computer readable memory 134 may comprise RAM, ROM, flash memories, hard drives, or any non-transitory memory device capable of storing machine-readable instructions such that the machine-readable instructions can be accessed and executed by the processor 132. The machine-readable instruction set may comprise logic or algorithm(s) written in any programming language of any generation (e.g., 1GL, 2GL, 3GL, 4GL, or 5GL) such as, for example, machine language that may be directly executed by the processor 132, or assembly language, object-oriented programming (OOP), scripting languages, microcode, etc., that may be compiled or assembled into machine readable instructions and stored in the non-transitory computer readable memory 134. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any computer programming language, as pre-programmed hardware elements, or as a combination of hardware and software components. While the embodiment depicted in FIG. 2 includes a single non-transitory computer readable memory 134, other embodiments may include more than one memory module.

Still referring to FIG. 2, the inertial measurement unit 140 includes one or more sensors for measuring and reporting angular rotation rates and accelerations in specific directions. For example, the inertial measurement unit 140 may include gyroscopes and accelerometers. The inertial measurement unit 140 may be configured to measure and report lateral accelerations of the vehicle 104 such as accelerations in the lateral direction across the vehicle due to turning maneuvers and longitudinal accelerations of the vehicle 104 such as accelerations along the length of the vehicle due to speeding up or breaking the vehicle 104. The vehicle controller 130 may be configured to log, as a function of time, values of lateral acceleration, longitudinal acceleration, and angular rotation rates of the vehicle 104 as signals from the inertial measurement unit 140 are received over the CAN bus 120. An odometer 142 is also included on a vehicle 104 to measure the distance a vehicle 104 travels. The vehicle controller 130 may be configured to log as a function of time distances traveled as signals from the odometer 142 are received over the CAN bus 120.

Still referring to FIG. 2, the location positioning system 150, such as a GPS, may be coupled to the CAN bus 120 and communicatively coupled to the vehicle controller 130 of the vehicle 104. The location positioning system 150 is capable of generating location information indicative of a location of the vehicle 104, for example, by receiving one or more GPS signals from one or more GPS satellites. The GPS signals communicated to the vehicle controller 130 via the CAN bus 120 may include location information comprising a National Marine Electronics Association (NMEA) message, a latitude and longitude data set, a street address, a name of a known location based on a location database, or the like. Additionally, the location positioning system 150 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The vehicle controller 130 may monitor and log the locations a vehicle 104 travels as location tracking data defining a pattern of usage of the vehicle 104.

The vehicle 104 also includes the auxiliary power system 152. The auxiliary power system 152 includes one or more AC and/or DC outlets for connecting peripheral devices to the vehicle 104. Peripheral devices may be connected to interface with the vehicle 104 and/or receive power from a power storage device of the vehicle 104. In some embodiments, the vehicle controller 130 monitors and logs the auxiliary power consumption via signals on the CAN bus 120. It should be understood that the auxiliary power system 152 may operate when ignition of the vehicle 104 is active or not active.

The vehicle 104 also includes the vehicle speed sensor 156 coupled to the CAN bus 120 and communicatively coupled to the vehicle controller 130. The vehicle speed sensor 156 may be any sensor or system of sensors for generating a signal indicative of vehicle speed. For example, without limitation, a vehicle speed sensor 156 may be a tachometer that is capable of generating a signal indicative of a rotation speed of a shaft of the vehicle 104 engine or a drive shaft. Signals generated by the vehicle speed sensor 156 may be communicated to the vehicle controller 130 and converted a vehicle speed value. The vehicle speed value is indicative of the speed of the vehicle 104. In some embodiments, the vehicle speed sensor 156 comprises an opto-isolator slotted disk sensor, a Hall Effect sensor, a Doppler radar, or the like. In some embodiments, a vehicle speed sensor 156 may comprise data from the location positioning system 150 for determining the speed of a vehicle 104. The vehicle speed sensor 156 may be provided so that the vehicle controller 130 may determine when the vehicle 104 accelerates, maintains a constant speed, slows down or is comes to a stop. The vehicle controller 130 may log the speed of the vehicle 104 as a time dependent variable based on signals from the vehicle speed sensor 156 provided over the CAN bus 120.

Additionally, the vehicle 104 may be enabled to be operated in one or more drive modes 160. The drive modes 160 include, for example, but are not limited to, a two-wheel drive mode, a four-wheel drive mode, a towing mode, a vehicle stability control mode, and the like. Selection of the drive mode 160 may be automatically implemented by the vehicle controller 130 in response to road conditions or events triggered by sensor inputs such as the loss of traction to one or more of the wheels of the vehicle 104. The selection of the drive mode 160 may also be made manually by the driver.

Still referring to FIG. 2, vehicles are commonly equipped with vehicle-to-vehicle communication systems. Some of the systems rely on the network interface hardware 170. The network interface hardware 170 may be coupled to the CAN bus 120 and communicatively coupled to the vehicle controller 130. The network interface hardware 170 may be any device capable of transmitting and/or receiving data with the network 110 or directly with a device such as the computing device 102, the server 103, or the mobile device 105. Accordingly, the network interface hardware 170 can include a communication transceiver for sending and/or receiving any wired or wireless communication. For example, the network interface hardware 170 may include an antenna, a modem, a LAN port, a Wi-Fi card, a WiMax card, mobile communications hardware, near-field communication hardware, satellite communication hardware and/or any wired or wireless hardware for communicating with other networks and/or devices. In one embodiment, network interface hardware 170 includes hardware configured to operate in accordance with a Bluetooth wireless communication protocol. In another embodiment, the network interface hardware 170 may include a Bluetooth send/receive module for sending and receiving Bluetooth communications to/from the network 110 and/or another vehicle and/or device.

As noted hereinabove, the components depicted in FIG. 2 of the vehicle 104 are exemplary in nature. The vehicle 104 may have fewer components or include other components not depicted, and the vehicle controller 130 may log the activity of those components based on signals on the CAN bus 120. As described in more detail herein, the system 100 may be configured to collect various data from the vehicle 104, and specifically from the components of the vehicle 104. For example, the system 100 may be configured to utilize the pattern of usage of the vehicle 104 in determining whether the vehicle 104 meets criteria for vehicle sharing.

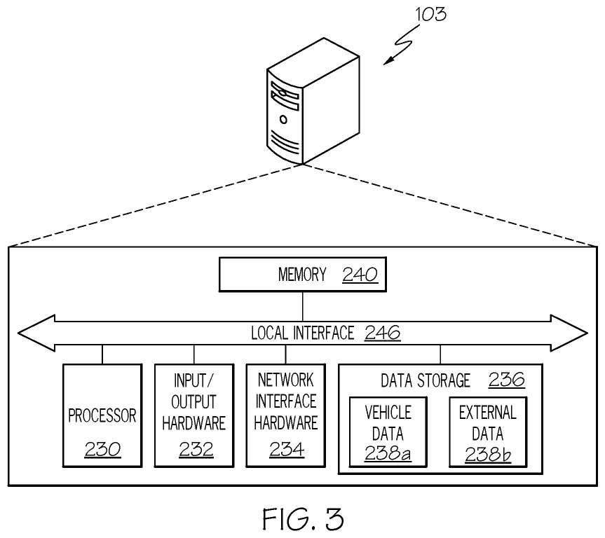

Turning to FIG. 3, an illustrative schematic of a controller, such as the sever 103, according to the embodiments of the present disclosure is depicted. While FIG. 3 depicts the controller as the server 103, it is understood that the processes described herein may be implemented on the computing device 102 or the mobile device 105. Moreover, it is understood that the server 103, the computing device 102 and/or the mobile device 105 may be implemented in the system 100 and execute one or more steps of the processes described herein. For purposes of explanation of the processes for determining whether a vehicle meets criteria for vehicle sharing according to embodiments of the present disclosure, the processes are described with reference to implementation by the server 103.

In some embodiments, the server 103 includes a processor 230, input/output hardware 232, network interface hardware 234, a data storage 236, which may store vehicle data 238a and/or external data 238b searchable by type and/or location associated with the vehicle 104, and a memory component 240. The data storage 236 may be connected with one or more databases. The vehicle data 238a and the external data 238b may be updated based on the data from the vehicle 104 and/or the data from the one or more databases. The memory 240 may be machine readable memory (which may also be referred to as a non-transitory processor readable memory). The memory component 240 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 240 may be configured to implement one or more artificial intelligence models that are trained to receive the vehicle data 238a and the external data 238b associated with the vehicle 104. The artificial intelligence models may include one or more machine learning models and/or access to databases.

A local interface 246 is also included in FIG. 2 and may be implemented as a bus or other interface to facilitate communication among the components of the controller.

The processor 230 may include any processing component(s) configured to receive and execute programming instructions (such as from the data storage 236 and/or the memory 240).

The instructions may be in the form of a machine readable instruction set stored in the data storage 236 and/or the memory 240. The input/output hardware 232 may include a monitor, keyboard, a mouse, a printer, a camera, a microphone, a speaker, and/or other device for receiving, sending, and/or presenting data. The network interface hardware 234 may include any wired or wireless networking hardware, such as a modem, a LAN port, a Wi-Fi card, a WiMax card, mobile communications hardware, and/or other hardware for communicating with other networks and/or devices.

The data storage component 236 may reside local to and/or remote from the server 103 and may be configured to store one or more pieces of data from the computing device 102, the server 103, the vehicle 104, the mobile device 105 and/or other components.

The vehicle data 238a (e.g., vehicle specification, vehicle factors, or the like) may include, for example, fuel efficiency and fuel type of the vehicle 104, data associated with the drive modes 160 available for the vehicle 104, and/or one or more functionality of the vehicle 104. The vehicle data 238a may include data associated with fuel efficiency, and for example, fuel efficiency based on an engine type, style, make, and/or model of the vehicle 104. In embodiments, the vehicle data 238a may include data from other sources such as survey responses from a user, information generated or received by, or stored in the mobile device 105, the computing device 102, the server 103, or the like. The vehicle data 238a may be obtained from a vehicle manufacturer provided information. The vehicle data 238a may be obtained based on vehicle identification number (VIN). The vehicle data 238a may be obtained from the vehicle 104.

The external data 238b may include, for example, data associated with weather, climate, fuel prices (e.g., gasoline prices, electricity prices, etc.), infrastructure availability, or the like. The external data 238b may be used with the vehicle data 238a to determine demand of the vehicle 104. In embodiments, the external data 238b may include data from other sources such as survey responses, information generated or received by, or stored in the mobile device 105 or the computing device 102, or the server 103, or the like. The external data 238b may include a number of vehicles offered for sharing or a number of vehicles required to meet the demand. The external data 238b may be obtained from external databases connected to the system 100.

As described above, different regions may have different demands or priorities in terms of selecting a vehicle for solicitation for sharing. For example, different regions may have higher demand for a vehicle with a specific vehicle function or type.

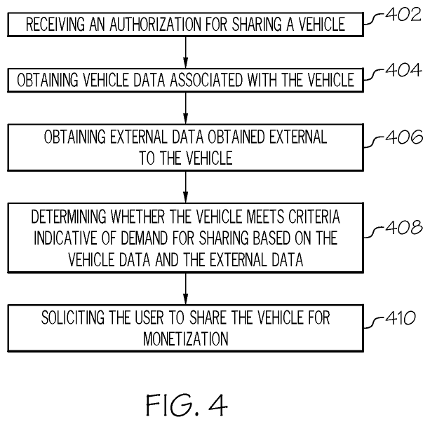

Methods implemented by the server 103, computing device 102, the mobile device 105 and the vehicle 104 will now be described in more detail with respect to the flow diagrams depicted in FIG. 4. FIG. 4 will be discussed together with reference to the description herein.

Embodiments include processes for sharing a vehicle based on the vehicle data 238a and the external data 238b.

At block 402, the example method comprises receiving an authorization for sharing the vehicle 104. The authorization may be received by various components of the system 100 (e.g., the computing device 102, the mobile device 105, the server 103, or the vehicle 104). The authorization for sharing the vehicle 104 may add the vehicle 104 to a list of vehicles for sharing offered by the system 100. The authorization process may allow the vehicle 104 to opt in for sharing. However, the authorization may not allow the vehicle 104 to be shared immediately. The vehicle 104 may be further subject to determination of suitability for sharing. For example, the vehicle 104 may be required to meet certain criteria determined based on the vehicle data 238a and the external data 238b.

At block 404, the method further comprises collecting the vehicle data 238a associated with the vehicle 104. The vehicle data 238a may provide various information related to a vehicle location, a vehicle downtime, a vehicle body type, a vehicle size, a vehicle fuel type, and a fuel efficiency of the vehicle 104. The vehicle data 238a may further include functionality, dimensions, accessories, or the like as described above in connection with FIG. 3. The system 100 may be configured to collect the pattern of usage of the vehicle 104. The collected pattern of usage of the vehicle 104 may provide information indicative of when the vehicle 104 is unused, and therefore available for sharing. For example, when the vehicle 104 is regularly used during night time, the vehicle 104 may be determined to be available for sharing during day time. Also, the vehicle data 238a may include location information of the vehicle 104. For example, the vehicle data 238a may indicate the vehicle 104 is located in state A during a specific period of time, and in state B during another specific period of time. This information may be used to determine where and when the vehicle 104 should be offered to share. As discussed above in connection with FIG. 3, the vehicle data 238a may be collected from the vehicle 104. The vehicle data 238a may be collected from the vehicle 104, from data provided by the manufacturer of the vehicle 104, and/or from the user input.

At block 406, the method comprises obtaining the external data 238b obtained external to the vehicle 104. The external data 238b may be unrelated to the vehicle 104 and provide information that may be used to determine demand of the vehicle 104 for sharing. The external data 238b may be associated with a specific region at a specific time.

For example, certain types of vehicles are more favorable for sharing in warm or hot weather or climate. For example, any regions during summer and/or regions having a warm climate may have higher demands for certain types of vehicles including trucks, large passenger vehicles for outdoor activities, or vehicles having a sun roof. For another example, any regions during winter and/or regions having a cold climate may have higher demands for certain types of vehicles including all wheel drive or all-terrain vehicles or vehicles having a heated seat or steering wheel.

As another example, fuel prices where the vehicle 104 is offered for sharing or the vehicle 104 is requested for sharing may be used to determine demand for sharing the vehicle 104. There may be a better engine type, style, make, and/or model of the vehicle 104 that has higher demand for a certain region based on driving needs and/or the economics of fuel costs in a certain region (e.g., a region where the vehicle 104 is authorized to be shared and/or a region where the vehicle 104 is requested to be shared). The term “better” may refer a vehicle having a lower emissions output than another, providing a greater cost savings through the operation of the vehicle, or that more completely deliver on the needs such as seating capacity, range, towing capability, cargo space, fuel economy, or the like.

As used herein, the region may be defined by the vehicle's typical travel routes, a radius from a point of interest, for example, a location of home, work place, and/or school, a region around a location that the vehicle 104 is frequently visited, or the like. There may be various ways to define the region. In some embodiments, the region may be a predefined region such as by state, city, geographic location (e.g., northeast US, mid-Atlantic US, southeast US, southern US, west coast US, northwest US, northern midwest US, midwest US), or the like. The region may be defined based on climate.

As yet another example, infrastructure availability may be used to determine demand of the vehicle 104 for sharing. Charging locations for electric vehicles may provide a favorable demand for electric vehicles. The infrastructure availability may be updated based on the updated data. The infrastructure availability may be defined by densities of vehicle charging locations within the region. For example, where the density of the electronic charging locations is high, fully electric vehicles may have higher demand than hybrid vehicles or gasoline vehicles. Fuel cost also may affect demand of certain vehicles. For example, a region having low gasoline cost may be favorable for gasoline vehicles, and a region having high gasoline cost may be favorable for electric vehicles (e.g., hybrid or fully electric, or the like).

The external data 238b may also indicate a certain event is scheduled at a certain location during a certain time period. Such data may be obtained from a personal calendar of the user, from external databases, or a known calendar schedule (e.g., holidays, observances, festive days, and religious holidays). The certain event may change the criteria for sharing or the degree of demand associated with the vehicle factors of the vehicle data 238a.

At block 408, the method comprises determining whether the vehicle 104 meets criteria indicative of demand for sharing based on the vehicle data 238a and the external data 238b. A degree of demand of the vehicle 104 may be determined based on the external data 238b. For example, the vehicle data 238a may indicate the vehicle 104 is located or offered to be shared in a certain location, and the external data 238b may indicate the certain location has high electric charging infrastructure availability, and is near at the beach. Therefore, the system 100 may determine that there is a high demand of hybrid or fully electric SUV vehicles in the certain location based on the external data 238b. In some embodiments, the vehicle 104 may be ranked among other vehicles offered to be shared based on the vehicle data 238a and the degree of demand of the vehicle 104. For example, hybrid or fully electric SUV vehicles may be ranked higher than hybrid or fully electric sedan vehicles. For another example, vehicles with a sun roof may be ranked higher than vehicles without a sun roof. The vehicles may be ranked based on various factors associated with the vehicle data 238a. The system 100 may determine only SUV vehicles meet the criteria based on the vehicle data 238a and the external data 238b. The criteria may change based on vehicle availability. For example, the criteria may be less stringent when there are fewer vehicles offered to share than a certain number. Similarly, the criteria may be more stringent when there are more vehicles offered to share than the certain number. The vehicle data 238a and the external data 238b may be processed and analyzed by the system 100 using an artificial intelligence model.

At block 410, the method comprises soliciting the user to share the vehicle 104 for monetization in response to the determination that the vehicle 104 meets the criteria for sharing. The user may be notified via a user interface (e.g., the mobile device 105, the computing device 102, the vehicle display of the vehicle 104, or the like). The notification may provide a confirmation button to allow the user to confirm the vehicle 104 to be shared. The notification may provide information associated with the scope of sharing (e.g., the area and/or the time duration to be shared). The notification may provide an electronic link to the information associated with the scope of sharing, which allows the user to have access to the information. The notification may provide an electronic link to review, edit, and approve the scope of sharing. The edited scope of sharing may be submitted to the system 100 for further consideration. The notification may include how much monetary value the user may receive if the vehicle 104 is shared based on the scope of sharing. The monetary value may be changed based on the edited scope of the sharing.

In embodiments, the method may further include automatically scheduling the vehicle 104 for sharing when it is determined that the vehicle 104 meets the criteria for sharing based on the vehicle data 238a and the external data 238b. The automatically scheduled sharing of the vehicle 104 may be notified to the user via the user interface. The user interface may notify the user that the vehicle 104 is scheduled for sharing at a certain time period and/or at a certain location.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method for sharing a vehicle, the method comprising:
receiving an authorization for sharing the vehicle;
obtaining vehicle data associated with the vehicle;
obtaining external data obtained external to the vehicle;
determining whether the vehicle meets criteria indicative of demand for sharing based on the vehicle data and the external data; and
notifying, in response to the determination that the vehicle meets the criteria for sharing, a user to share the vehicle for monetization.

2. The method of claim 1, further comprising:
determining a pattern of usage based on the vehicle data; and
determining availability of the vehicle based on the pattern of usage,
wherein the user is further notified in response to the determination that the vehicle is available for sharing.

3. The method of claim 1, wherein the vehicle data is obtained from the vehicle.

4. The method of claim 1, wherein the vehicle data includes one or more of a vehicle location, a vehicle downtime, a vehicle body type, a vehicle size, a vehicle fuel type, or a fuel efficiency of the vehicle.

5. The method of claim 1, further comprising:
determining a degree of demand of the vehicle based on the external data, wherein the demand for sharing is determined based on the degree of demand of the vehicle.

6. The method of claim 1, wherein the external data is associated with a specific region at a specific time.

7. The method of claim 1, wherein the external data includes one or more of a season, weather, a fuel price, or an event.

8. The method of claim 1, further comprising:
determining availability of the vehicle based on schedule information of the user, wherein the user is further notified in response to the determination that the vehicle is available for sharing.

9. A system for sharing a vehicle, the system comprising:
a processor; and
a memory coupled to the processor,
wherein the processor is configured to:
receive an authorization for sharing the vehicle;
obtain vehicle data associated with the vehicle;
obtain external data obtained external to the vehicle;
determine whether the vehicle meets criteria for sharing based on the vehicle data and the external data; and
notify, in response to the determination that the vehicle meets the criteria for sharing, a user to share the vehicle for monetization.

10. The system of claim 9, wherein the processor is further configured to:
determine a pattern of usage based on the vehicle data; and
determine availability of the vehicle based on the pattern of usage,
wherein the user is further notified in response to the determination that the vehicle is available for sharing.

11. The system of claim 9, wherein the vehicle data is obtained from the vehicle.

12. The system of claim 9, wherein the vehicle data includes one or more of vehicle downtime, a vehicle body type, a vehicle size, a vehicle fuel type, and a fuel efficiency of the vehicle.

13. The system of claim 9, wherein the processor is further configured to:
determine a degree of demand of the vehicle based on the external data, wherein the demand for sharing is determined based on the degree of demand of the vehicle.

14. The system of claim 9, wherein the external data is associated with a specific region at a specific time.

15. The system of claim 9, wherein the external data includes one or more of a season, weather, a fuel price, or an event.

16. The method of claim 1, further comprising:
determining availability of the vehicle based on schedule information of the user, wherein the user is further notified in response to the determination that the vehicle is available for sharing.

17. A non-transitory computer-readable storage medium storing executable instructions that, when executed by a processor, cause the processor to:
receive an authorization for sharing the vehicle;
obtain vehicle data associated with the vehicle;
obtain external data obtained external to the vehicle;
determine whether the vehicle meets criteria for sharing based on the vehicle data and the external data; and
notify, in response to the determination that the vehicle meets the criteria for sharing, a user to share the vehicle for monetization.

18. The non-transitory computer-readable storage medium of claim 17, wherein the executable instructions further cause the processor to:
determine a pattern of usage based on the vehicle data; and
determine availability of the vehicle based on the pattern of usage,
wherein the user is further notified in response to the determination that the vehicle is available for sharing.

19. The non-transitory computer-readable storage medium of claim 17, wherein the vehicle data is obtained from the vehicle.

20. The non-transitory computer-readable storage medium of claim 17, wherein the executable instructions further cause the processor to:
determine a degree of demand of the vehicle based on the external data, wherein the demand for sharing is determined based on the degree of demand of the vehicle.
